(19) United States
(12) Patent Application Publication
(10) Pub. No.: US 2005/0175813 A1
(43) Pub. Date: Aug. 11, 2005

(54) Aluminum-fiber laminate

(76) Inventors: A. Lew Wingert, Maple Valley, WA (US); Sven E. Axter, Bellevue, WA (US); Gary D. Tuss, Bellevue, WA (US); Edward Li, Seattle, WA (US); Willard N. Westre, Bellevue, WA (US); William B. Grace, Seattle, WA (US); Kay Y. Blohowiak, Issaquah, WA (US); Moe K. Soleiman, Bellevue, WA (US); Judy S. Chen, Bellevue, WA (US)

Correspondence Address: BLACK LOWE & GRAHAM PLLC, 701 FIFTH AVENUE, SUITE 4800, SEATTLE, WA, 98104, US

(21) Appl. No.: 10/775,564

(22) Filed: Feb. 10, 2004

(51) Int. Cl. B32B 5/12

(52) U.S. Cl. 428/113; 428/116

(57) ABSTRACT

An exemplary fiber metal laminate includes at least two metallic layers and at least one fiber layer bonded between the two metallic layers. The fiber layer includes a resin matrix and organic polymeric fibers with a modulus of elasticity greater than 270 GPa. The polymeric fibers may include poly diimidazo pyridinylene fibers. The metallic layers may include pre-treated aluminum alloy layers.

### FIELD OF THE INVENTION

This invention relates generally to composite materials, and, more specifically, to fiber-reinforced laminates.

### BACKGROUND OF THE INVENTION

Equipment such as aircraft commonly use aluminum alloys for structure and skin material. Because it is desirable to reduce weight of an aircraft, use of lightweight composite materials has also become common on aircraft. These lightweight composites include fiber metal laminates (FML). As an example, composite aluminum-fiber laminates and other metal-fiber laminates have been developed utilizing carbon and glass fiber layers interspersed between layers of aluminum or other metals. Low modulus fibers such as glass often may not have a sufficiently high modulus of elasticity to produce a laminate able to carry significant loads without potentially over-stressing or fatiguing the aluminum layers when the laminate is under repeated loading.

It would be desirable to use fibers having high strength characteristics, such as high modulus fibers. However, the use of high modulus fibers, such as graphite, in making fiber metal laminates often produces laminates with physical properties that are less than desirable for certain applications.

### SUMMARY OF THE INVENTION

In one aspect, this invention is a fiber-metal laminate comprising: at least two metallic layers and at least one fiber layer disposed between the metallic layers; wherein the fiber layer contains a resin matrix and organic polymeric fibers having a modulus of elasticity of at least 270 GPa.

In another aspect, this invention is a fiber-metal laminate comprising: at least two layers of an aluminum alloy; and at least one resin-fiber ply bonded between the aluminum alloy layers, the ply including a resin matrix and poly diimidazo pyridinylene fibers.

In a third aspect, this invention is a composite aircraft component comprising: at least two aluminum alloy foil layers each having a thickness of at least 0.004 inches and no greater than 0.025 inches; and at least one polymeric composite layer bonded between the at least two foil layers, the composite layer including a resin matrix and aligned poly diimidazo pyridinylene fibers.

In a fourth aspect, this invention is a method for producing a fiber-metal laminate, the method comprising: providing a plurality of metallic layers; aligning a plurality of polymer fibers having a modulus of elasticity of greater than 270 GPa into at least one fiber layer; and sandwiching the fiber layer between the plurality of metallic layers.

In a fifth aspect, this invention is a fiber-metal laminate produced according to a method comprising: providing a plurality of metallic layers; aligning a plurality of polymer fibers having a modulus of elasticity of greater than 270 GPa into at least one fiber layer; and sandwiching the at least one fiber layer between the plurality of metallic layers.

It has been discovered that the fiber-metal laminates, composite components and the method for making them of this invention advantageously provide laminates and components with physical properties and corrosion resistance that is particularly useful in aircraft applications. These and other advantages of the invention will be apparent from the description which follows.

### BRIEF DESCRIPTION OF THE DRAWINGS

The preferred and alternative embodiments of the present invention are described in detail below with reference to the following drawings.

FIG. 1 is a cutaway isometric drawing of an exemplary fiber metal laminate according to an embodiment of the present invention;

FIG. 2 is a cutaway isometric drawing of an exemplary fiber metal laminate according to an alternate embodiment of the present invention;

FIG. 3 is a cutaway isometric drawing of an exemplary fiber metal laminate according to another alternate embodiment of the present invention;

FIG. 4A is a cross-section of an exemplary fiber metal laminate according to a further alternate embodiment of the present invention;

FIG. 4B is a cross-section of an exemplary fiber metal laminate according to a further alternate embodiment of the present invention;

FIG. 5A is an isometric view of an exemplary fiber metal laminate with a honeycomb core layer of the present invention;

FIG. 5B is a cross section of an exemplary fiber metal laminate aircraft fuselage segment including a honeycomb core layer of the present invention; and

FIG. 6 is a flow chart of an exemplary method for manufacturing a fiber metal laminate of the present invention.

### DETAILED DESCRIPTION OF THE INVENTION

By way of overview, exemplary embodiments of the present invention provide a fiber metal laminate. At least two metallic layers are provided and at least one fiber layer is bonded between the two metallic layers. The fiber layer suitably includes a resin matrix and organic polymeric fibers with a modulus of elasticity greater than 270 GPa.

In accordance with further aspects of the invention, the polymeric fibers may include poly diimidazo pyridinylene fibers. In accordance with other aspects of the invention, the metallic layers may include pre-treated aluminum alloy layers.

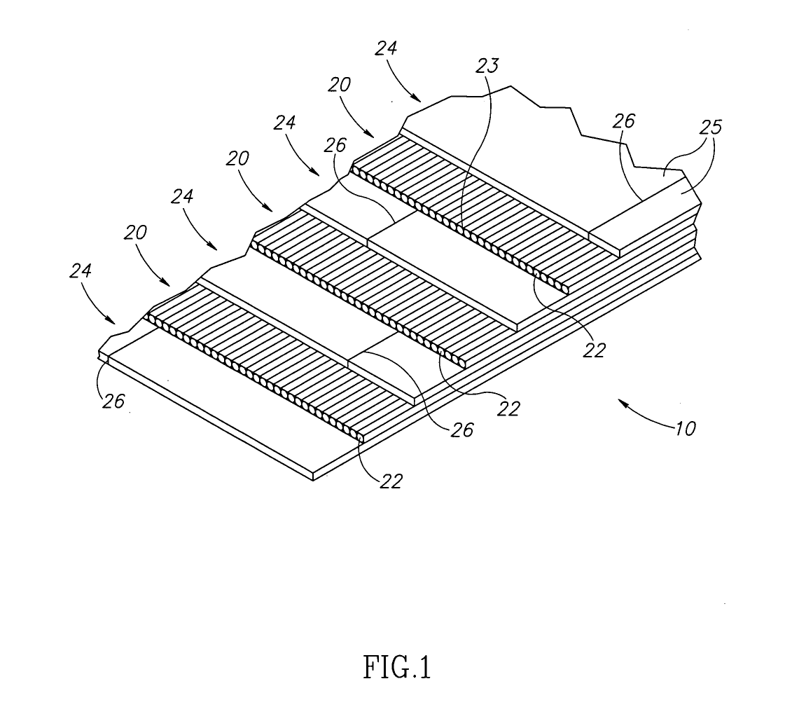

Referring to FIG. 1, an exemplary, non-limiting fiber metal laminate 10 includes four metallic layers 24 and three fiber layers 20. Each fiber layer 20 is bonded between two of the metallic layers 24. In this non-limiting example, the laminate 10 includes seven layers. The outer two layers are the metallic layers 24. However, it will be appreciated that any number of layers may be provided as desired for a particular application.

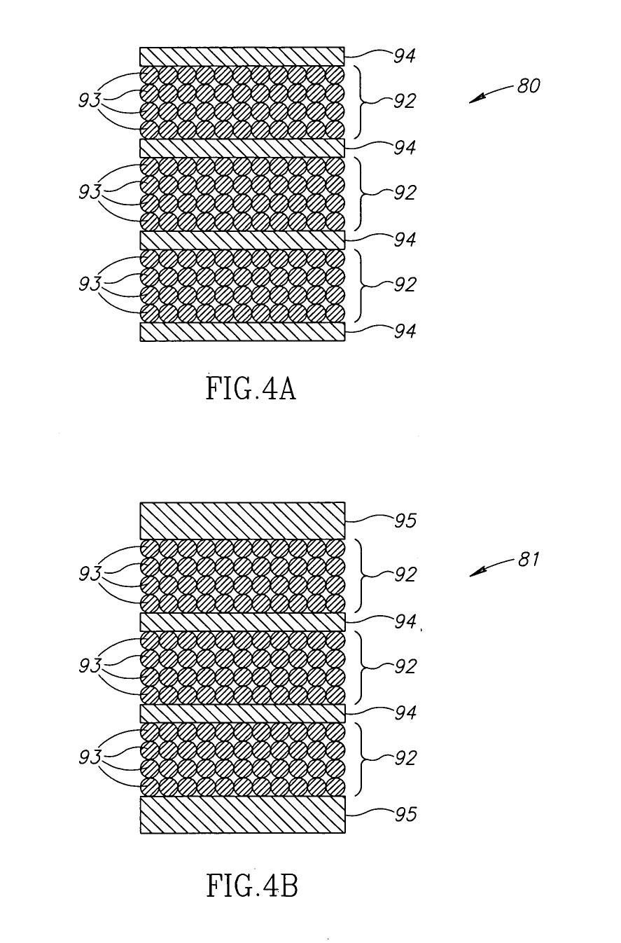

By way of example and not limitation, in one presently preferred embodiment the metallic layers 24 include heat treatable aluminum alloy foil layers having a thickness of at least 0.004 inches and no greater than 0.025 inches. Greater thickness foil layers may also be utilized, as described further in connection with FIG. 4B below. The metallic layers 24 may include butt joints 26 between foil sections 25 within the metallic layers 24. The fiber layers 20 also suitably may include butt-jointed sections (not shown) to permit the laminate 10 to be manufactured in large sheets, depending upon the planned application for the laminate 10. Suitable aluminum alloy foils for the metallic layers 24 include heat treatable and non-heat treatable aluminum alloys of the 2000, 5000, 6000, and 7000 series, including without limitation 2024, 7075, and 7055. Other suitable metallic foils may include titanium and high strength stainless steel.

Use of the metallic layers 24 in conjunction with the fiber layers 20 allows the use of fewer or no cross-plys, as opposed to pure fiber composite laminates, for structures and skins that are primarily under tensile loads. The metallic layers 24 carry stress about equally in all directions in the plane of the metallic layer 24, while the fiber layers 20 typically exhibit substantially higher strength in a direction generally parallel to the fibers 22 than in a direction oblique to the fibers 22. Metallic layers 24 in the laminate 10 also add benefits of electrical conductivity, a moisture barrier, resistance to weather, and damage tolerance. The metallic layers 24 exhibit greater resistance to sharp objects than a fiber layer 20 alone, and show visible impact damage when impacted by other objects. In FIG. 1, the fiber layers 20 all have their fibers 22 aligned in the same direction. It will be appreciated that in areas requiring high shear stiffness, for example such as aircraft wings and some fuselage areas, the fibers 22 may be aligned at any angle to each other, including 45° to a primary stress direction.

The fiber layers 20 preferably include very high modulus polymer fibers that are not galvanically reactive with aluminum. The high modulus fibers 22 carry most of the stress applied to the laminate 10, while minimizing over-stressing and fatigue to the metallic layers 24. The very high modulus non-reactive polymer fibers permit the laminate 10 to be only 10 percent to 40 percent metal by weight. At the same time, for example for areas such as structural joints where additional multidirectional stress carrying capacity for complex loading is desired, the laminate 10 may be 10 percent to 50 percent metal by volume.

In one preferred embodiment, the fiber layers 20 include a resin matrix (not shown) that holds the polymer fibers 22. The resin matrix is often a thermo-hardening material; permitting heat cure of the laminate. Exemplary resin matrixes include, by way of example and not limitation, thermal curing epoxies and resins such as TORAY™ 3900-2, CYTEC™ CYCOM™ 934, and HEXCEL™ F155; bismaleimide based adhesives such as CYTEC™ 5250-4; and Cyanate Esters such as STESALIT™ PN-900. The matrix resins typically may be heat cured. The resins may be formed with the fibers 22 into “pre-pregs”, that is pre-assembled pre-impregnated layers often including multiple layers of the fibers 22. Multiple pre-pregs (not shown) may form a fiber layer 20.

In one preferred embodiment of the present invention the laminate 10 includes very high modulus non-reactive polymer fibers 22 with moduli of elasticity over 270 GPa. Exemplary non-reactive fibers with very high moduli of elasticity include without limitation poly2,6-diimidazo[4,5-b4′,5′-e]pyridinylene-1,4(2,5-dihydroxy)phenylenes (“PIPD”), such as M5™ fiber, manufactured by Magellan Systems International, with a modulus of elasticity over 300 GPa. An alternate non-reactive very high elastic modulus polymer is poly (p-phenylene-2,6-benzobisoxazole) (“PBO”), such as ZYLON™, manufactured by Toyobo Co., Ltd of Osaka, Japan. The fibers 22 are typically assembled in alignment and embedded in a resin matrix to form fiber layers 20.

In a presently preferred embodiment, the metallic layers 24 are bonded to the fiber layers 20 during assembly of the laminate 10. The fiber layers 20 suitably may bond themselves to the metallic layers 24 when the laminate 10 is assembled and held under pressure during heat curing. However, bond strengths between the fiber layers 20 and the metallic layers 24 can be enhanced if desired, by way of example and not limitation, by pre-treatment of the metallic layers 24 and by using a separate adhesive between the metallic layers 24 and the fiber layers 20.

Suitable optional adhesives for increasing bond strength if desired between the fiber layers 20 and the metallic layers 24 include heat cured epoxies, such as without limitation Applied Poleramic, Inc., MSR-355 HSC™, and Applied Poleramic, Inc., MSR-351™. These epoxies (not shown) serve as an interphase adhesive between the fiber layers 20 and the metallic layers 24.

The metallic layers 24 themselves suitably may be pre-treated to increase adhesion to the fiber layers 20, thereby increasing the strength and durability of the laminate 10. Pre-treatments suitably may include a wide variety of metallic pre-treatments including acid or alkaline etching, conversion coatings, phosphoric acid anodizing, and the like. Such pre-treatments may increase surface roughness, thereby facilitating a stronger physical bond with the adhesive, or may facilitate a better chemical bond with the adhesive. In one presently preferred embodiment, a further alternate pre-treatment of applying a sol-gel coating to the metallic layers 24 may be utilized prior to assembly of the laminate 10. The sol-gel process commonly uses inorganic or organo-metallic pre-cursors to form an inorganic polymer sol. Sol-gel coatings include zirconium-silicone coatings, such as those described in Blohowiak, et al., U.S. Pat. Nos. 5,849,110; 5,869,140; and 6,037,060, all of which are hereby incorporated by reference. The resulting inorganic polymer sol coating serves as an interphase layer between the metal layers 24 and the fiber layers 20 when they are bonded together. Pre-treatments may also include grit blasting. Grit blasting may also suitably cold work the alloys in the metallic layers 24. Further exemplary pre-treatments suitably may include heat treatment and wet honing.

It will be appreciated that including the metallic layers 24 in the laminate 10 permits all of the fibers 22 of the fiber layers 20 to be in alignment. Typically in composites that do not include the metallic layers 24, a 10 percent-90° rule is applied. As is known, this means that in a composite, approximately 10 percent of the fibers are oriented 90° to the primary axis of stress. The 10 percent of the fibers oriented at 90° to the primary axis of stress prevent disintegration in sheer of the composite. When the metallic layers 24 are combined with the fiber layers 20 such as the high elastic modulus, non-reactive polymer fibers 22, as low as 0 percent of the fibers 22 may be oriented at 90° to the primary stress. Thus, a laminate 10 with all of the fibers 22 aligned in a common direction advantageously may be assembled and utilized without the added materials and manufacturing steps of including cross-plys.

In a presently preferred embodiment, the laminate 10 is suitably assembled by first pre-treating the metallic layers 24 as described above, if desired. The fiber layers 20 are then interspersed between the metallic layers 24. Adhesive (not shown) is applied at each boundary between a metallic layer 24 and a fiber layer 20. The resulting stack is placed in a vacuum bag. The vacuum bag is placed into an autoclave. A vacuum is applied to the vacuum bag, and the autoclave is pressurized. The autoclave is heated to and held for a sufficient amount of time at a temperature suitable to activate and cure the adhesive (not shown) and the resin matrix (not shown) thereby curing the laminate 10. It will be appreciated that the temperatures and hold times for the autoclave correspond to those suitable for cure of the adhesive (not shown) and the resin matrix (not shown). In an exemplary embodiment, where TORAY™ 3900-2 with a 350° F. cure resin is utilized for the resin matrix (not shown), the autoclave is heated to approximately 350° F. and held at that temperature for approximately 120 minutes. Typical cure temperatures for heat curing resin adhesives and matrix resins include cures between 250° and 350° F.±10° for approximately two hours. It will be appreciated that heat curing of the adhesive (not shown) in the matrix resin (not shown) may also simultaneously heat treat or heat age the metallic layers 24.

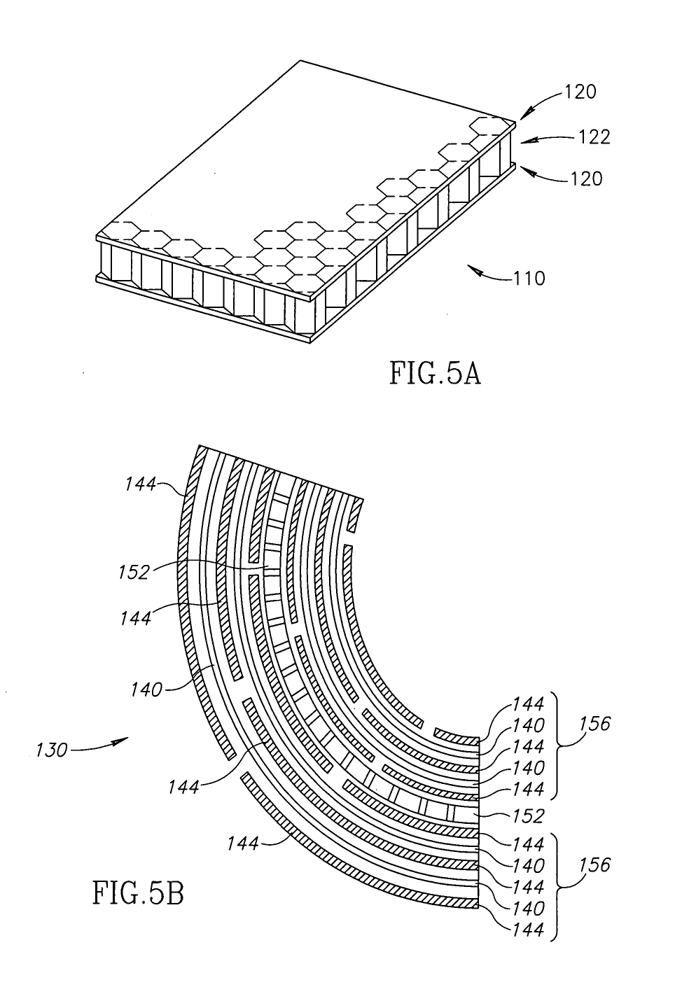

It will also be appreciated that during forming, the laminate 10 may be formed over a form or in a complex shape prior to cure. This permits the laminate 10 to be formed and cured into curved or segmented shapes such as a curved section described below in connection with FIG. 5B.

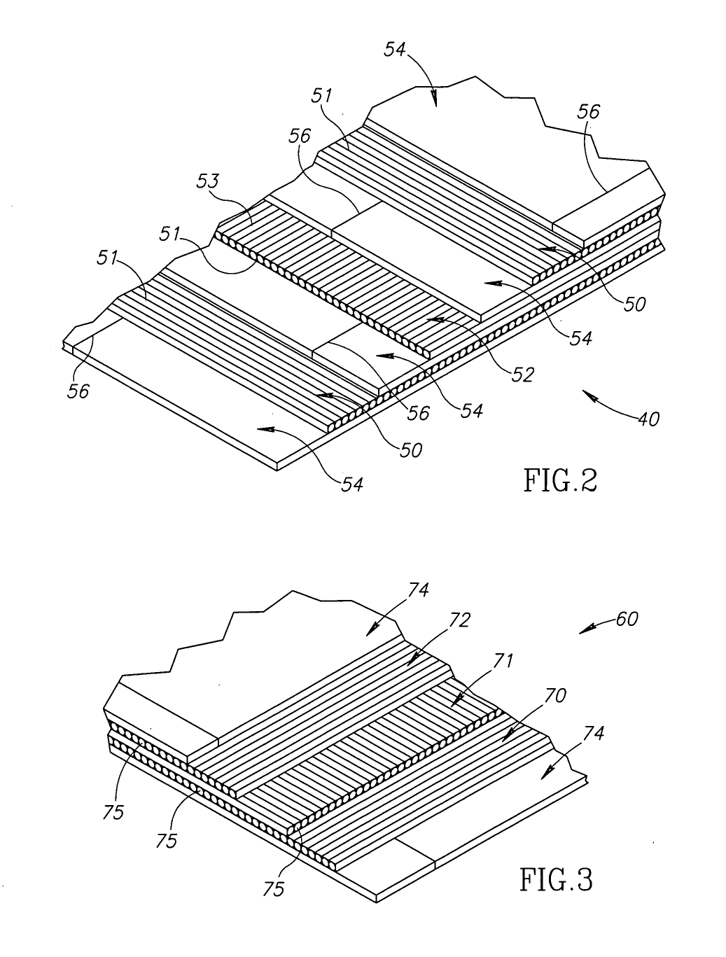

Turning to FIG. 2, an alternate exemplary laminate 40 is shown in cutaway isometric view. Like the laminate 10 (FIG. 1), the laminate 40 includes four metallic layers 54 plus three fiber layers 50 sandwiched between the metallic layers 54. However, it will be appreciated that any number of layers may be provided as desired for a particular application. The metallic layers 54 are assembled of metallic foils with butt joints 56 internal to the metallic layers 54. The metallic layers 54, fiber layers 50, matrix resins (not shown), adhesives (not shown), and assembly and cure methods for this laminate 40 suitably are as described above in connection with the laminate 10 (FIG. 1). However, in this exemplary embodiment, the fibers 51 in the fiber layers 50 are not all aligned in a common direction as in the laminate 10 (FIG. 1). Instead, two of the fiber layers 50 have their fibers 51 in alignment, and the third fiber layer 50 has its fibers 51 oriented 90° to the direction of the other two fiber layers 50. As a result, the laminate 40 has greater multi-directional strength than the laminate 10 (FIG. 1), at the expense of somewhat decreased strength in the direction of alignment of the fibers 51 in the two aligned fiber layers 50. As noted above, the laminate 40 may also include fibers aligned in any combination of directions, including 45° to each other, suitable for the application where the laminate 40 is being utilized.

It will be appreciated that, multiple fiber layers 50 may be positioned between two metallic layers 54, thereby increasing the ratio of fiber layers 50 to metallic layers 54. Referring now to FIG. 3, an exemplary laminate 60 includes two metallic layers 74. Three fiber layers 70, 71, and 72 are sandwiched between the two metallic layers 70. In this embodiment the three fiber layers include two primary fiber layers 70 and 72 with their fibers 75 oriented in a primary direction, and one secondary fiber layer 71 intermediate the two primary fiber layers 70 and 72 with its fibers oriented 90° to the direction of the fibers 75 of the primary layers 70 and 72. It will be appreciated that multiple fiber layers may be assembled together and sandwiched between a varying number of metallic layers 74 depending upon the stress to be applied to the component utilizing the laminate 60. In FIG. 3, the materials and assembly methods also suitably are those as described in reference to FIG. 1.

Referring now to FIG. 4A, a further exemplary laminate 80 of the present invention includes four metallic layers 94. In this embodiment, by way of example and not limitation, between each pair of the metallic layers 94 is a multi-tier fiber layer 92. Each multi-tier fiber layer 92 includes four tiers or layers of fibers 93, all in common alignment. The resulting laminate 80 thus includes twelve tiers of fibers 93 and four metallic layers 94. The materials and assembly methods used for the laminate 80 suitably are those as described in reference to FIG. 1.

For some applications it may be advantageous for one or more of the metallic layers of the laminate to be thicker than the other layers. In FIG. 4B, another exemplary laminate 81 is similar to the laminate 80 of FIG. 4A except laminate 81 includes outermost metallic layers 95 thicker than the other metallic layers 94. Thicker metallic layers, by way of example but not limitation, may provide additional lightning protection when incorporated on the outside of the laminate 81, may provide additional thickness for landing fasteners, brackets, or other connections, or may provide additional thickness for later chemical milling to form more complicated surface configurations and thicknesses.

It will be appreciated that a hollow core layer may be incorporated into a high modulus fiber-metal laminate. Referring now to FIG. 5A, an exemplary hollow core laminate 110 includes a honeycomb core layer 122 sandwiched between two fiber metallic composite layers 120 such as those described in reference to FIGS. 1 through 4 above. Without limitation, the hollow core layer 122 in the exemplary laminate 110 is a hexagonal celled honeycomb layer 122. Such honeycombs include aluminum honeycombs manufactured by Hexcel Corporation. It will be appreciated that incorporating a hollow core 122 into a fiber metal laminate 110 increases the stiffness of the laminate 110.

The high modulus fiber laminate of the present invention may be incorporated into aircraft components. Referring now to FIG. 5B, a fuselage skin section 130 incorporates exemplary laminates of the present invention. The fuselage section 130 is formed into a cylindrical or conical shape (shown here in two-dimensional cross section), as desired for a particular application. In this exemplary embodiment, the fuselage section 130 includes a hollow core layer 152 sandwiched between high modulus fiber layers 140 and metallic layers 144 that are all assembled and cured into one pre-formed fuselage section 130. In this exemplary embodiment, on each side of the hollow core layer 152 is a multi-layer fiber metal laminate assembly 156. Each assembly 156 includes three metallic layers 144 of butt joined aluminum alloy foil and two fiber layers 140. The fiber layers 140 are sandwiched between the metallic layers 144. The fuselage section 130 is assembled of the materials and in the manner described in reference to FIG. 1 above. The resulting fuselage section 130 thus includes (from outside to inside) a metallic layer 144, a fiber layer 140, a metallic layer 144, a fiber layer 140, a metallic layer 144, the hollow core layer 152, a metallic layer 144, a fiber layer 140, a metallic layer 144, a fiber layer 140, and, a final metallic layer 144. As mentioned above, it will be appreciated that having a metallic layer 144 at the outside and inside of the fuselage section 130 suitably adds moisture protection, damage resistance, and weather resistance to the assembly.

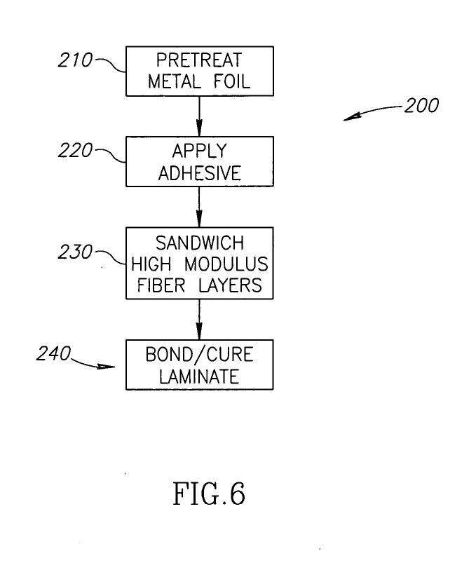

Turning to FIG. 6, an exemplary method 200 of assembling the fiber metal laminate of the present invention begins at a block 210 at which metallic foil layers are pre-treated. Pre-treatments at the block 210 include pre-treatments such as sol-gel coating, as described in reference to FIG. 1 above. After pre-treatment of the metallic foil, adhesive is applied to areas that will form junctions between the metal and fiber layers at a block 220. At a block 230 the laminate assembly is laid up by sandwiching fiber layers between metallic layers. At a block 240 the laminate is cured in a manner described in reference to FIG. 1 above. Curing typically includes heat curing. This results in bonding of the high modulus fiber layers to the metallic layers thereby forming the fiber metal laminate of the present invention.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A fiber-metal laminate comprising: at least two metallic layers and at least one fiber layer disposed between the metallic layers; wherein the fiber layer contains a resin matrix and organic polymeric fibers having a modulus of elasticity of at least 270 GPa.

2. The laminate of claim 1, wherein the polymeric fibers are electrically substantially non-conducting.

3. The laminate of claim 1, wherein the polymeric fibers are not galvanically reactive with the metallic layers.

4. The laminate of claim 1, wherein the polymeric fibers include poly diimidazo pyridinylene fibers.

5. The laminate of claim 4, wherein the poly diimidazo pyridinylene fibers include poly{2,6-diimidazo[4,5-b4′,5′-e]pyridinylene-1,4(2,5-dihydroxy)phenylene} fibers.

6. The laminate of claim 1, wherein the at least two layers include an aluminum alloy.

7. The laminate of claim 1, wherein the aluminum alloy includes a heat treatable aluminum alloy.

8. The laminate of claim 1, wherein the at least two layers include a titanium alloy.

9. The laminate of claim 1, wherein the at least two layers include a stainless steel alloy.

10. The laminate of claim 1, wherein the resin matrix includes an epoxy resin.

11. The laminate of claim 1, wherein the at least two metallic layers constitute no more than 40 percent by weight of the laminate.

12. The laminate of claim 1, wherein the at least two metallic layers constitute at least 10 percent and no more than 50 percent by volume of the laminate.

13. The laminate of claim 1, wherein at least 90 percent of the fibers are substantially aligned in one direction.

14. The laminate of claim 13, wherein about 100 percent of the fibers are aligned in the substantially same direction.

15. The laminate of claim 1, wherein at least 10 percent of the fibers are aligned at a first direction 45° from a second direction to which at a majority of the fibers are aligned.

16. The laminate of claim 1, wherein the at least a portion of the fibers are aligned in a plurality of directions.

17. The laminate of claim 1, wherein the fibers include continuous fibers.

18. The laminate of claim 1, which contains at least 3 and no more than 15 metallic layers.

19. The laminate of claim 1, wherein the at least one fiber layer includes between 3 and 15 plies of fibers.

20. The laminate of claim 1, wherein the at least two metallic layers each have a thickness of at least 0.004 inch and no more than 0.025 inch.

21. The laminate of claim 1, wherein the surfaces of the metallic layers are pre-treated by phosphoric acid anodizing.

22. The laminate of claim 1 wherein the surfaces of the metallic layers are pre-treated by coating with an interphase layer.

23. The laminate of claim 22, wherein the interphase layer includes a sol-gel surface preparation.

24. The laminate of claim 1 which additionally comprises a layer of an adhesive resin between the fiber layer and the metallic layers, wherein the adhesive resin is different from the resin matrix.

25. The laminate of claim 24 wherein the adhesive includes an epoxy adhesive.

26. The laminate of claim 1, further comprising at least one core layer disposed between the at least two metallic layers.

27. The laminate of claim 26, wherein the core layer includes a honeycomb core.

28. A fiber-metal laminate comprising:
at least two layers of aluminum alloy; and
at least one resin-fiber ply bonded between the aluminum alloy layers, the ply including a resin matrix and poly diimidazo pyridinylene fibers.

29. The laminate of claim 28, wherein the poly diimidazo pyridinylene fibers include poly{2,6-diimidazo[4,5-b4′,5′-e]pyridinylene-1,4(2,5-dihydroxy)phenylene} fibers.

30. The laminate of claim 28, wherein the aluminum alloy includes a heat treatable aluminum alloy.

31. The laminate of claim 28, wherein the resin-fiber ply is bonded between the aluminum alloy layers with an adhesive resin different from the matrix resin.

32. The laminate of claim 28, wherein the resin matrix includes an epoxy resin.

33. The laminate of claim 28, wherein the metallic layers constitute less than 40 percent by weight of the laminate.

34. The laminate of claim 28, wherein the at least two metallic layers constitute between 10 percent and 50 percent by volume of the laminate.

35. The laminate of claim 28, wherein at least 90 percent of the fibers are substantially aligned in one direction.

36. The laminate of claim 35, wherein about 100 percent of the fibers are aligned in the substantially same direction.

37. The laminate of claim 28, having at least 3 and no greater than 15 metallic layers.

38. The laminate of claim 28, wherein the at least one fiber layer includes between 3 and 15 layers of aligned polymer fibers.

39. The laminate of claim 28, wherein the metallic layers each have a thickness of at least 0.004 inch and 0.025 inch.

40. The laminate of claim 28, wherein the surfaces of the metallic layers are pre-treated by phosphoric acid anodizing.

41. The laminate of claim 28 wherein the surfaces of the metallic layers are pre-treated by coating with an interphase layer of resin.

42. The laminate of claim 28, wherein the surfaces of the metallic layers are pre-treated with a sol-gel surface preparation.

43. The laminate of claim 28, further comprising at least one hollow core layer disposed between the at least two metallic layers.

44. The laminate of claim 43, wherein the hollow core layer includes a honeycomb core.

45. A composite aircraft component comprising:
at least two aluminum alloy foil layers each having a thickness in a range from 0.004 inches to 0.025 inches; and
at least one polymeric composite layer bonded between the at least two foil layers, the composite layer including a resin matrix and aligned poly diimidazo pyridinylene fibers.

46. The laminate of claim 45, wherein the poly diimidazo pyridinylene fibers include poly{2,6-diimidazo[4,5-b4′,5′-e]pyridinylene-1,4(2,5-dihydroxy)phenylene} fibers.

47. The laminate of claim 45, wherein the resin matrix includes an epoxy resin.

48. The laminate of claim 45, wherein the at least two metallic layers constitute no more than 40 percent by weight of the laminate.

49. The laminate of claim 45, wherein the at least two metallic layers constitute at least 10 percent and no greater than 50 percent by volume of the laminate.

50. The laminate of claim 45, wherein greater than 90 percent of the fibers are substantially aligned in one direction.

51. The laminate of claim 45, wherein about 100 percent of the fibers are substantially aligned in one direction.

52. The laminate of claim 45, wherein at least 10 percent of the fibers are aligned in a first direction 45° to a second direction a majority of the remaining fibers are aligned.

53. The laminate of claim 45, wherein the at least a portion of the fibers are aligned in a plurality of different directions.

54. The laminate of claim 45, wherein at least two final layers include at least 3 and no greater than 15 foil layers.

55. The laminate of claim 45, wherein the at least one polymeric composite layer includes at least three 3 and no more than 15 polymeric composite layers.

56. A method for producing a fiber-metal laminate, the method comprising:
providing a plurality of metallic layers;
aligning a plurality of polymer fibers having a modulus of elasticity of greater than 270 GPa into at least one fiber layer; and
sandwiching the at least one fiber layer between the plurality of metallic layers.

57. The method of claim 56, further comprising bonding the at least one high modulus fiber layer to the plurality of metallic layers adjoining the high modulus fiber layer using an adhesive resin different from the matrix resin.

58. The method of claim 5.6, further comprising pretreating the plurality of metallic layers.

59. The method of claim 58, wherein pretreating includes pretreating with a sol-gel coating.

60. The method of claim 56, wherein the poly diimidazo pyridinylene fibers include poly{2,6-diimidazo[4,5-b4′,5′-e]pyridinylene-1,4(2,5-dihydroxy)phenylene} fibers.

61. The method of claim 56, wherein the plurality of metallic layers include an aluminum alloy.

62. The method of claim 56, wherein the plurality of metallic layers include a titanium alloy.

63. The method of claim 56, wherein the plurality of metallic layers include a stainless steel alloy.

64. The method of claim 56, wherein the resin matrix includes an epoxy resin.

65. The method of claim 56, wherein the at least two metallic layers constitute less than 40 percent by weight of the laminate.

66. The method of claim 56, wherein the at least two metallic layers constitute between 10 percent and 50 percent by volume of the laminate.

67. The method of claim 56, further comprising forming a hollow core between the plurality of metallic foil layers.

68. The method of claim 67, wherein forming a hollow core includes forming a honeycomb core.

69. A fiber-metal laminate produced according to a method comprising:
providing a plurality of metallic layers;
aligning a plurality of polymer fibers having a modulus of elasticity of greater than 270 GPa into at least one fiber layer; and
sandwiching the at least one fiber layer between the plurality of metallic layers.

70. The laminate of claim 69, produced according to the method further comprising bonding the at least one high modulus fiber layer to the plurality of metallic layers adjoining the high modulus fiber layer.

71. The laminate of claim 69, produced according to the method further comprising pretreating the plurality of metallic layers.

72. The method of claim 71, wherein pretreating includes pretreating with a sol-gel coating.
